(19) United States
(12) Patent Application Publication
(10) Pub. No.: US 2022/0019704 A1
(43) Pub. Date: Jan. 20, 2022

(54) 3D OBJECT INTERNAL HOLLOWING FORM LIGHTWEIGHT METHOD BASED ON FUNCTION REPRESENTATION

(71) Applicant: DALIAN UNIVERSITY OF TECHNOLOGY, Dalian ,Liaoning (CN)

(72) Inventors: Shengfa WANG, Dalian, Liaoning (CN); Jun YANG, Dalian, Liaoning (CN); Longfei ZHANG, Dalian, Liaoning (CN); Zhongxuan LUO, Dalian, Liaoning (CN)

(21) Appl. No.: 17/258,019

(22) PCT Filed: Jul. 6, 2020
(86) PCT No.: PCT/CN2020/100320

§ 371 Date: Jan. 5, 2021

(30) Foreign Application Priority Data
Mar. 5, 2020 (CN) 202010146901.7

(51) Int. Cl. G06F 30/10; G06F 30/23

(52) U.S. Cl. CPC G06F 30/10; G06F 2111/10; G06F 30/23

(57) ABSTRACT

The present invention discloses a 3D shape internal hollowing form lightweight method based on function representation, and belongs to the field of computer-aided design. First, function representation is used and effective analytical calculation of shape optimization is explored; then, under the constraint of given external conditions, the stress structure design of a 3D object as well as the problems of center of mass, stand stability, tumbler design and buoyancy of an object are modeled by building an energy function model, and a corresponding discrete computation is given; finally, the above modeling problems are geometrically optimized to obtain an optimized internal shape of the object under given constraint conditions. The present invention greatly shortens the design and optimization cycles of this kind of cavity structures and can give theoretically optimal results.

### TECHNICAL FIELD

The present invention belongs to the technical field of computer-aided design, engineering design and manufacturing, and relates to a 3D object internal hollowing form lightweight method based on function representation, which is applicable to general design and optimization of internal hollowing of components, and is particularly applicable to hollowing optimization of 3D printed objects.

### BACKGROUND

Internal hollowing is an effective lightweight method, which can satisfy the functional purpose without the need of changing the external shape of a 3D object. This method can greatly reduce the material consumption and manufacturing cost, and is widely used in the field of environmental protection and material saving. However, the existing method has the problems such as local self-intersection, unsmooth shape representation, and being difficult to accurately describe the complex internal structure. Therefore, the key point to improve a 3D object hollowing optimization method is to avoid the problem of self-intersection, and at the same time make the shape description of an internal cavity of a 3D object more accurate, smoother, and more convenient for calculation.

### SUMMARY

In view of the above-mentioned problems, the present invention proposes a shape hollowing optimization design scheme based on function representation. First, a model of a 3D object with cavities is represented by a function; and then the structure of the object is modeled and optimized by the continuity and differentiability of the function to provide an efficient design and optimization framework. The framework can be executed directly on the function, and can be applied to a variety of shape optimization problems, such as the problem of structural strength, the problem of equilibrium and the problem of buoyancy. The key idea is to make full use of function representation to explore the automatic and efficient analytical calculation of the problem of hollowing shape optimization, thus to avoid time-consuming meshing. Specifically, a surface of a given boundary in other forms (such as triangular mesh representation) is converted into function representation first, a radial basis function (RBF) is used at this moment to construct a representation function of inner and external surfaces, and other function representations can also be used. A solid part between the inner and external surfaces is defined and expressed by a continuous function distance field, and operations such as curved surface offset or skeleton are no longer required.

Therefore, the method of the present invention has a larger available design space, while the problem of self-intersection in the traditional boundary representation can be avoided by merging the inner surface. In addition, as all the processes of the optimization framework can be executed directly on the function without the need of meshing processing, the present invention is a more efficient and accurate representation and optimization solution. The method of the present invention can be applied to the optimization problems of structural strength, stand stability, tumblers, buoyancy targets, etc.

The technical solution of the present invention is: A 3D object internal hollowing form lightweight method based on function representation, comprising the following specific steps:

(I) Shape Function Representation of 3D Object with Cavities

A 3D object with cavities is expressed as ϕ°(r)≥0, wherein ϕ°(r) is a representation function of a model:

ϕ°(r)=min(ϕ̅(r),−ϕ(r)) (1)

Wherein r=(x,y,z) is the coordinate of a point on the model, ϕ̅(r) is an external surface function of the object, and ϕ(r)=ϕ̅(r)−t(r) is an inner surface function of the object; and t(r)≥0 is a continuous function of thickness field, which is expressed as follows:

t(r)=Eᵢ₌₁ⁿ^{_{c}}aᵢRᵢ(r)+Q(r) (2)

Wherein Rᵢⱼ=R(|Pᵢ−Pⱼ|) is a radial basis function which represents the distance between points Pᵢ and Pⱼ, {Pᵢ}Eᵢ₌₁ⁿ^{_{c}} are uniformly sampled on the external surface of the model, n_{c} is the number of control points (the value range is usually [200, 500]), Q(r)=b₁x+b₂y+b₃z+b₄ is an offset term, {aᵢ} is the weight of Rᵢ(r), and {bᵢ} is the weight of the offset term Q(r). Since the external surface of the 3D object is not changed, the sampling points and weights only need to be calculated once in the following formula optimization.

(II) 3D Object Internal Hollowing Form Lightweight Modeling and Optimization Based on Function Representation

Model stress and boundary conditions are given, a given problem is modeled by the function representation of the 3D object, so as to reduce material consumption as much as possible in the given material volume and boundary constraint conditions, and the specific steps are as follows:

1. Problem Modeling

1.1 Modeling of the Problem of Structural Strength

For the given model stress and boundary conditions, the problem of structural strength is modeled as follows:

$$\begin{matrix} {min}_{t ( r )} I = {\int }_{{Ω}_{M}} H ( {ϕ}^{o} ( r ) ) f \cdot udV + {\int }_{{τ}_{s}} s \cdot udS & ( 3 ) \\ s . t . {\int }_{{Ω}_{M}} H ( {ϕ}^{o} ( r ) ) 𝔼 \text{:} ɛ ( u ) \text{:} ɛ ( v ) dV = {\int }_{{Ω}_{M}} H ( {ϕ}^{o} ( r ) ) f \cdot vdV + {\int }_{{τ}_{s}} s \cdot vdS , ∀ v ϵ {U}_{ad} & \\ u = \overline{u} , on {τ}_{u} & \\ {\int }_{{Ω}_{M}} H ( {ϕ}^{o} ( r ) ) dV \leq \overline{V} & \end{matrix}$$

Wherein Ω_{M} is the whole region occupied by a given model M, ϕ° (*) is a representation function of the model, f is a body force, s is a surface force defined on a Riemann boundary τₛ, S is the area of the Riemann boundary τₛ, u is a displacement field, v is a test function defined on the region Ω_{M}, U_{ad}={v|v∈Sob¹(Ω_{M}), v=0 on τᵤ}, Sob¹ is the first order soblev space, ε is the second order linear strain tensor, and [symbol] is the fourth order isotropic elasticity identity tensor which is determined by elastic modulus and Poisson ratio; ū is a prescribed displacement defined on a Dirichlet boundary τᵤ, V is the volume of the model M, V̅ is a volume constraint value, and H(x) is a regularized Heaviside function which is expressed as:

$$H ( x ) = \{ \begin{matrix}1 , & if x > β , \\ \frac{3 ( 1 - α )}{4} ( \frac{x}{β} - \frac{{x}^{3}}{3 {β}^{3}} ) + \frac{( 1 + α )}{2} , & if - β \leq x \leq β , \\ α , & if x < β\end{matrix} , \qquad ( 4 )$$

Wherein α and β are threshold parameters, which usually take the values of α=0.0001 and, β=0.001.

1.2 Modeling of the Problems of Mass and Center

For the problems of mass and center of the 3D object, the mass m and center of mass c of a model are respectively expressed as follows:

$$m = {M}_{1} \\ c = {[ {c}_{x} , {c}_{y} , {c}_{z} ]}^{T} = {\frac{1}{m} [ {M}_{x} , {M}_{y} , {M}_{z} ]}^{T} \qquad ( 5 )$$

### Wherein,

M_{μ}=∫_{Ω}_{_{M}}H(ϕ°(r))μdV,μ=1,x,y,z (6)

ϕ°(r) is a representation function of the model, Ω_{M} is the whole region occupied by a given model M, V is the volume of the model M, and H(x) is a regularized Heaviside function.

1.2.1 Model of Stand Stability of Object

For the stand stability of an object, modeling is carried out as follows:

$${min}_{t ( r )} S ( t ) = {c}_{x}^{2} + {c}_{y}^{2} + {c}_{z}^{2} \\ s . t . {( {c}_{x} + {c}_{y} )}^{2} - {( r - ɛ )}^{2} \leq 0 \qquad ( 7 )$$

Wherein t(r)≥0 represents a function of thickness field to be solved, S(t) is an objective function, S(t) is minimized to make the center of mass of the object as low as possible, cₓ, c_{y} and c_{z} are the centers of mass of the object respectively in x, y and z directions, r is the radius of the maximum inscribed circle of a contact point convex hull, and ε is a safety factor (generally, ε=0.1).

1.2.2 Model of Tumbler

For the problem of a 3D tumbler, the problem is modeled as follows:

$${min}_{t ( r )} R ( t ) = {c}_{z} \\ s . t . {c}_{x} = 0 \\ {c}_{y} = 0 \\ {c}_{z} - r + ɛ \leq 0 \qquad ( 8 )$$

Wherein t(r)≥0 represents a function of thickness field to be solved, R(t) is an objective function, R(t) is minimized to make the center of mass of the object in z-axis direction as low as possible, cₓ, c_{y} and c_{z} are the centers of mass of the object respectively in x, y and z directions, r is the radius of the maximum inscribed circle of a contact point convex hull, and ε is a safety factor (ε=0.1 by default).

1.2.3 Model of Buoyancy

For the problem of buoyancy of a 3D object, modeling is carried out as follows:

$${min}_{t ( r )} B ( t ) = {( {ρ}_{l} {V}_{l} - {ρ}_{m} {V}_{m} )}^{2} \\ s . t . {c}_{x} - {c}_{buoy} , x = 0 \\ {c}_{y} - {c}_{buoy} , y = 0 \\ {c}_{z} - {c}_{buoy} , z \leq 0 \qquad ( 9 )$$

Wherein t(r)≥0 represents a function of thickness field to be solved, B(t) is an objective function, B(t)=0 represents that an object floats in water, cₓ, c_{y} and c_{z} are the centers of mass of the object respectively in x, y and z directions, ρₗ is the density of a liquid, Vₗ is the volume of the object submerged in a given liquid, ρₘ is the density of the object, Vₘ is the volume of the object, and c_{bouy,x}, c_{bouy,y} and c_{bouy,z} are centers of mass of the corresponding space of the liquid occupied by immersion respectively in x, y and z directions.

2. Problem Optimization

An improved finite element method can be used to solve the above-mentioned modeling problems. Only a finite number of elements need to be used as integration elements. In order to improve efficiency, a coarse and fine element strategy is used in the present invention, i.e., each coarse element is further divided into more fine elements inside (for example, each coarse mesh is provided with 27 fine elements inside). Further, the sensitivity analysis (see formula (11)) of variables is obtained by discrete computation of the above-mentioned problems, and is finally substituted into an optimizer (for example, a method of moving asymptotes) to obtain optimization results.

Specifically, in view of the above-mentioned model representation and problem modeling, only a corresponding parameter value {tᵢ}ᵢ₌₁ⁿ^{_{c}} at a control point of a function of thickness field t(r) need to be calculated, and the function of thickness field t(r) is expressed as:

t(r)=Σᵢ₌₁ⁿ^{_{c}}Nᵢ(r)tᵢ, (10)

Wherein Nᵢ(r)=[RQ]U⁻¹, R_{i,j}=R(|Pᵢ−Pⱼ|) is a radial basis function which represents the distance between points Pᵢ and Pⱼ, Q is an offset matrix of a corresponding offset term,

$${U}^{- 1} = {[ \begin{matrix}R & Q \\ {Q}^{T} & 0\end{matrix} ]}^{- 1} ,$$

and is the number of control points. Further, the problem of model optimization is transformed into the problem of optimization of the parameter {tᵢ}ᵢ₌₁ⁿ^{_{c}}. Therefore, the derivation of the objective function and the constraint function with respect to the optimized variables is carried out as follows:

$$\frac{\partial V}{\partial {t}_{i}} = \frac{1}{8} {\sum }_{j = 1}^{{N}_{b}} {\sum }_{k = 1}^{8} \frac{\partial H ( {ϕ}_{jk}^{o} )}{\partial {t}_{i}} \\ \frac{\partial {M}_{μ}}{\partial {t}_{i}} = \frac{1}{8} {\sum }_{j = 1}^{{N}_{b}} {\sum }_{k = 1}^{8} \frac{\partial H ( {ϕ}_{jk}^{o} )}{\partial {t}_{i}} , \\ \frac{\partial {c}_{x}}{\partial {t}_{i}} = \frac{1}{{m}^{2}} ( \frac{\partial {M}_{x}}{\partial {t}_{i}} m - \frac{\partial m}{\partial {t}_{i}} {M}_{x} ) , \\ \frac{\partial {c}_{y}}{\partial {t}_{i}} = \frac{1}{{m}^{2}} ( \frac{\partial {M}_{y}}{\partial {t}_{i}} m - \frac{\partial m}{\partial {t}_{i}} {M}_{y} ) , \\ \frac{\partial {c}_{z}}{\partial {t}_{i}} = \frac{1}{{m}^{2}} ( \frac{\partial {M}_{z}}{\partial {t}_{i}} m - \frac{\partial m}{\partial {t}_{i}} {M}_{z} ) , \qquad ( 11 )$$

Wherein N_{b} is the number of fine integration elements.

The calculation results of formula (11) are substituted into an optimizer to obtain an optimized {tᵢ}ᵢ₌₁ⁿ^{_{c}}, and thus to obtain a final optimization model, i.e., the internal shape of the object optimized in the given constraint conditions.

### The Present Invention has the Following Beneficial Effects

3D object hollowing form lightweight oriented to 3D printing can be used in the optimization of a stress structure and the stand stability of an object, tumbler design, buoyancy and other practical applications. The present invention proposes a method for representing a hollow object by a function, which is to conduct problem modeling and optimization to a model based on function representation. The present invention greatly shortens the design and optimization cycles of an object with cavities and can give theoretically optimal results. A model which is more material-saving and has a larger cavity volume while meeting constraint conditions can be obtained for an object with cavities designed by the present invention. In addition, since the present invention is operated directly on a function, time-consuming meshing in the traditional finite element optimization method is avoided, and analysis and optimization are more efficient. Such excellent properties ensure the applicability and manufacturability of a 3D object designed and optimized.

### DESCRIPTION OF DRAWINGS

FIG. 1 is a flow chart of the present invention;

FIG. 2 is a lightweight result diagram of adopting a method of the present invention (each dark part is a hollow part); wherein (a) shows results of stress optimization; (b) shows results of stand stability optimization; (c) shows results of tumbler optimization; and (d) shows results of the problem of buoyancy.

### DETAILED DESCRIPTION

Specific embodiments of the present invention are further described below in combination with accompanying drawings and the technical solution.

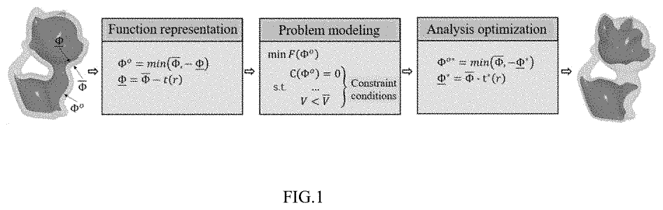

FIG. 1 is a flow chart of the present invention. The present embodiment takes standing stability as an example to illustrate the specific implementation of the present invention, which can be divided into the main steps of function representation of a 3D object with cavities, problem modeling, and optimization solving:

(I) Function Representation of 3D Object

In order to obtain an interpolation function representing the inner and external surfaces of a model, the values of weights {aᵢ} and {bᵢ} of the interpolation function in formula (2) need to be obtained. The function value f=1 of an external control point, the function value f=−1 of an internal control point, and the function value f=0 of a control point on the surfaces of the model are taken. Distance between the control points R_{if}=R(|Pᵢ−Pⱼ|) is calculated by an radial basis function; and the coordinates of the control points, the distance between the control points and the corresponding function values f of the control points are substituted into the interpolation function:

$$f ( r ) = {\sum }_{i = 1}^{{n}_{c}} {a}_{i} {R}_{i} ( r ) + Q ( r ) .$$

Thus the values of the weights {aᵢ} and {bᵢ} are obtained. A subset (A) of the control points on the external surface of the model is uniformly taken (n_{c}=500, and tᵢ is the function value of a control point), and a continuous thickness control function is obtained by formula (10):

t(r)=Σᵢ₌₁ⁿ^{_{c}}Nᵢ(r)tᵢ,

The external surface function of the model is ϕ̅(r)=f(r), and the inner surface function is ϕ(r)=ϕ̅(r)−t(r). Further, the function representation of the 3D object is:

ϕ°(r)=min(ϕ̅(r),−ϕ(r))=ϕ̅(r)+ϕ(r)−\sqrt{ϕ̅(r)²+ϕ(r)²}.

(II) Modeling and Optimization of 3D Object

1. Problem Modeling:

For the given model stress and boundary conditions, with the aim of structural energy minimization, and by taking model volume, stress and boundary conditions as constraints, a model of the problem of structural strength is substituted into formulas (5), (6) and (7) to obtain the following modeling:

$${min}_{t ( r )} S ( t ) = {c}_{x}^{2} + {c}_{y}^{2} + {c}_{z}^{2} , \\ s . t . {( {c}_{x} + {c}_{y} )}^{2} - {( r - ɛ )}^{2} \leq 0$$

2. Optimization Solving

After coarse and fine meshes are divided by a finite element analysis method, the problem of model optimization is transformed into the problem of optimization of the parameter {tᵢ}ᵢ₌₁ⁿ^{_{c}}. Therefore, the derivation of the objective function

$${min}_{t ( r )} S ( t ) = {c}_{x}^{2} + {c}_{y}^{2} + {c}_{z}^{2} ,$$

and the constraint condition s.t. (cₓ+c_{y})²−(r−ε)²≤0 with respect to the optimized variables is carried out

$$\frac{\partial V}{\partial {t}_{i}} = \frac{1}{8} {\sum }_{j = 1}^{{N}_{b}} {\sum }_{k = 1}^{8} \frac{\partial H ( {ϕ}_{jk}^{o} )}{\partial {t}_{i}}$$

$$\frac{\partial {M}_{μ}}{\partial {t}_{i}} = \frac{1}{8} {\sum }_{j = 1}^{{N}_{b}} {\sum }_{k = 1}^{8} \frac{\partial H ( {ϕ}_{jk}^{o} )}{\partial {t}_{i}}$$

$$\frac{\partial {c}_{x}}{\partial {t}_{i}} = \frac{1}{{m}^{2}} ( \frac{\partial {M}_{x}}{\partial {t}_{i}} m - \frac{\partial m}{\partial {t}_{i}} {M}_{x} ) , \\ \frac{\partial {c}_{y}}{\partial {t}_{i}} = \frac{1}{{m}^{2}} ( \frac{\partial {M}_{y}}{\partial {t}_{i}} m - \frac{\partial m}{\partial {t}_{i}} {M}_{y} ) , \\ \frac{\partial {c}_{z}}{\partial {t}_{i}} = \frac{1}{{m}^{2}} ( \frac{\partial {M}_{z}}{\partial {t}_{i}} m - \frac{\partial m}{\partial {t}_{i}} {M}_{z} ) ,$$

The derivation formula is substituted into an MMA optimizer to obtain an optimized {tᵢ}ᵢ₌₁ⁿ^{_{c}}, and thus to obtain a final optimization model.

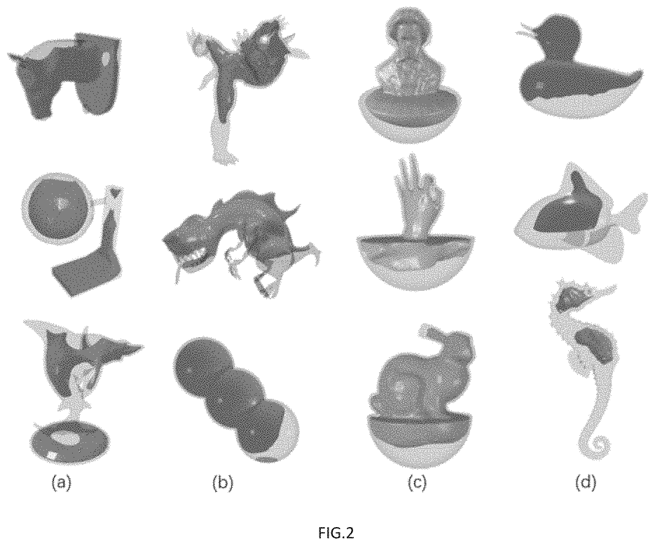

The lightweight results are shown in FIG. 2.

By using the above method to calculate on different 3D objects, ideal results can be achieved as shown by experiments. The results show that the present invention greatly shortens the design and optimization cycles of this kind of cavity structures and can give theoretically optimal results. A model obtained by the present invention has smoother internal cavities and is not limited by the number of cavities; and the model of the object has a lower center of mass, saves more material, and consumes less time in design and optimization.

1. A 3D object internal hollowing form lightweight method based on function representation, comprising the following specific steps:
(I) shape function representation of 3D object with cavities
a 3D object with cavities is expressed as ϕ°(r)≥0, wherein ϕ°(r) is a representation function of a model:
ϕ°(r)=min(ϕ̅(r),−ϕ(r)) (1)
wherein r=(x,y,z) is the coordinate of a point on the model, ϕ̅(r) is an external surface function of the object, and ϕ(r)=ϕ̅(r)−t(r) is an inner surface function of the object; and t(r)≥0 is a continuous function of thickness field, which is expressed as follows:
t(r)=Eᵢ₌₁ⁿ^{_{c}}aᵢRᵢ(r)+Q(r) (2)
wherein Rᵢⱼ=R(|Pᵢ−Pⱼ|) is a radial basis function which represents the distance between points Pᵢ and Pⱼ, {Pᵢ}Eᵢ₌₁ⁿ^{_{c}} are uniformly sampled on the external surface of the model, n_{c} is the number of control points, Q(r)=b₁x+b₂y+b₃z+b₄ is an offset term, {aᵢ} is the weight of Rᵢ(r), and {bᵢ} is the weight of the offset term Q(r);
(II) 3D object internal hollowing form lightweight modeling and optimization based on function representation model stress and boundary conditions are given, a given problem is modeled by the function representation of the 3D object, so as to reduce material consumption as much as possible in the given material volume and boundary constraint conditions, and the specific steps are as follows:
1. problem modeling
1.1 modeling of the problem of structural strength
for the given model stress and boundary conditions, the problem of structural strength is modeled as follows:
$${min}_{t ( r )} I = {\int }_{{Ω}_{M}} H ( {ϕ}^{o} ( r ) ) f \cdot udV + {\int }_{{τ}_{s}} s \cdot udS \\ s . t . {\int }_{{Ω}_{M}} H ( {ϕ}^{o} ( r ) ) 𝔼 : ɛ ( u ) : ɛ ( v ) dV = {\int }_{{Ω}_{M}} H ( {ϕ}^{o} ( r ) ) f \cdot vdV + {\int }_{{τ}_{s}} s \cdot vdS , ∀ v ∈ {U}_{ad} \\ u = \overline{u} , on {τ}_{u} \\ {\int }_{{Ω}_{M}} H ( {ϕ}^{o} ( r ) ) dV \leq \overline{V} \qquad ( 3 )$$
wherein Ω_{M} is the whole region occupied by a given model M, ϕ° (*) is a representation function of the model, f is a body force, s is a surface force defined on a Riemann boundary τₛ, S is the area of the Riemann boundary τₛ, u is a displacement field, v is a test function defined on the region Ω_{M}, U_{ad}={v|v∈Sob¹(Ω_{M}), v=0 on τᵤ}, Sob¹ is the first order soblev space, ε is the second order linear strain tensor, and [symbol] is the fourth order isotropic elasticity identity tensor which is determined by elastic modulus and Poisson ratio; ū is a prescribed displacement defined on a Dirichlet boundary τᵤ, V is the volume of the model M, V̅ is a volume constraint value, and H(x) is a regularized Heaviside function which is expressed as:
$$H ( x ) = \{ \begin{matrix}1 , & if x > β , \\ \frac{3 ( 1 - α )}{4} ( \frac{x}{β} - \frac{{x}^{2}}{3 {β}^{2}} ) + \frac{( 1 + α )}{2} , & if - β \leq x \leq β , \\ α , & if x < β\end{matrix} , \qquad ( 4 )$$
wherein α and β are threshold parameters;
1.2 modeling of the problems of mass and center
for the problems of mass and center of the 3D object, the mass m and center of mass c of a model are respectively expressed as follows:
$$m = {M}_{1} \\ c = {[ {c}_{x} , {c}_{y} , {c}_{z} ]}^{T} = {\frac{1}{m} [ {M}_{x} , {M}_{y} , {M}_{z} ]}^{T} \qquad ( 5 )$$
wherein,
M_{μ}=∫_{Ω}_{_{M}}H(ϕ°(r))μdV,μ=1,x,y,z (6)
ϕ°(r) is a representation function of the model, Ω_{M} is the whole region occupied by a given model M, V is the volume of the model M, and H(x) is a regularized Heaviside function;
1.2.1 model of stand stability of object
for the stand stability of an object, modeling is carried out as follows:
$${min}_{t ( r )} S ( t ) = {c}_{x}^{2} + {c}_{y}^{2} + {c}_{z}^{2} \\ s . t . {( {c}_{x} + {c}_{y} )}^{2} - {( r - ɛ )}^{2} \leq 0 \qquad ( 7 )$$
wherein t(r)≥0 represents a function of thickness field to be solved, S(t) is an objective function, S(t) is minimized to make the center of mass of the object as low as possible, cₓ, c_{y} and c_{z} are the centers of mass of the object respectively in x, y and z directions, r is the radius of the maximum inscribed circle of a contact point convex hull, and ε is a safety factor;
1.2.2 model of tumbler
for the problem of a 3D tumbler, the problem is modeled as follows:
$${min}_{t ( r )} R ( t ) = {c}_{z} \\ s . t . {c}_{x} = 0 \\ {c}_{y} = 0 \\ {c}_{z} - r + ɛ \leq 0 \qquad ( 8 )$$
wherein t(r)≥0 represents a function of thickness field to be solved, R(t) is an objective function, R(t) is minimized to make the center of mass of the object in z-axis direction as low as possible, cₓ, c_{y} and c_{z} are the centers of mass of the object respectively in x, y and z directions, r is the radius of the maximum inscribed circle of a contact point convex hull, and ε is a safety factor;
1.2.3 model of buoyancy
for the problem of buoyancy of a 3D object, modeling is carried out as follows:
$${min}_{t ( r )} B ( t ) = {( {ρ}_{l} {V}_{l} - {ρ}_{m} {V}_{m} )}^{2} \\ s . t . {c}_{x} - {c}_{buoy} , x = 0 \\ {c}_{y} - {c}_{buoy} , y = 0 \\ {c}_{z} - {c}_{buoy} , z \leq 0 \qquad ( 9 )$$
wherein t(r)≥0 represents a function of thickness field to be solved, B(t) is an objective function, B(t)=0 represents that an object floats in water, cₓ, c_{y} and c_{z} are the centers of mass of the object respectively in x, y and z directions, ρₗ is the density of a liquid, Vₗ is the volume of the object submerged in a given liquid, ρₘ is the density of the object, Vₘ is the volume of the object, and c_{bouy,x}, c_{bouy,y} and c_{bouy,z} are centers of mass of the corresponding space of the liquid occupied by immersion respectively in x, y and z directions;
2. problem optimization
a coarse and fine element strategy is used to solve a problem model, i.e., each coarse element is further divided into more fine elements inside; the sensitivity analysis of variables is obtained by discrete computation of a problem, and is finally substituted into an optimizer to obtain the optimization results; the details are as follows:
for problem modeling, a corresponding parameter value {tᵢ}ᵢ₌₁ⁿ^{_{c}} at a control point of a function of thickness field t(r) need to be calculated, and the function of thickness field t(r) is expressed as:
t(r)=Σᵢ₌₁ⁿ^{_{c}}Nᵢ(r)tᵢ, (10)
wherein Nᵢ(r)=[RQ]U⁻¹, R_{i,j}=R(|Pᵢ−Pⱼ|) is a radial basis function which represents the distance between points Pᵢ and Pⱼ, Q is an offset matrix of a corresponding offset term,
$${U}^{- 1} = {[ \begin{matrix}R & Q \\ {Q}^{T} & 0\end{matrix} ]}^{- 1} ,$$
and n_{c} is the number of control points; then the problem of model optimization is transformed into the problem of optimization of the parameter {tᵢ}ᵢ₌₁ⁿ^{_{c}}, and the derivation of the objective function and the constraint function with respect to the optimized variables is carried out as follows:
$$\frac{\partial V}{\partial {t}_{i}} = \frac{1}{8} {\sum }_{j = 1}^{{N}_{b}} {\sum }_{k = 1}^{8} \frac{\partial H ( {ϕ}_{jk}^{o} )}{\partial {t}_{i}} \\ \frac{\partial {M}_{μ}}{\partial {t}_{i}} = \frac{1}{8} {\sum }_{j = 1}^{{N}_{b}} {\sum }_{k = 1}^{8} \frac{\partial H ( {ϕ}_{jk}^{o} )}{\partial {t}_{i}} , \\ \frac{\partial {c}_{x}}{\partial {t}_{i}} = \frac{1}{{m}^{2}} ( \frac{\partial {M}_{x}}{\partial {t}_{i}} m - \frac{\partial m}{\partial {t}_{i}} {M}_{x} ) , \\ \frac{\partial {c}_{y}}{\partial {t}_{i}} = \frac{1}{{m}^{2}} ( \frac{\partial {M}_{y}}{\partial {t}_{i}} m - \frac{\partial m}{\partial {t}_{i}} {M}_{y} ) , \\ \frac{\partial {c}_{z}}{\partial {t}_{i}} = \frac{1}{{m}^{2}} ( \frac{\partial {M}_{z}}{\partial {t}_{i}} m - \frac{\partial m}{\partial {t}_{i}} {M}_{z} ) , \qquad ( 11 )$$
wherein N_{b} is the number of fine integration elements; and the calculation results of formula (11) are substituted into an optimizer to obtain an optimized {tᵢ}ᵢ₌₁ⁿ^{_{c}}, and thus to obtain a final optimization model, i.e., the internal shape of the object optimized in the given constraint conditions.
